(19) United States
(12) Patent Application Publication
(10) Pub. No.: US 2004/0039667 A1
(43) Pub. Date: Feb. 26, 2004

(54) Evaluation of financial aspects of a retirement benefit plan

(75) Inventors: Howard Winklevoss, Greenwich, CT (US); James Spaide, New Canaan, CT (US); Debbie Benner, Fairfield, CT (US); Mark Tillman, Stamford, CT (US); Mark Ruloff, Wilton, CT (US); Steve Strake, Greenwich, CT (US)

Correspondence Address: Charles N.J. Ruggiero, Esq., Ohlandt, Greeley, Ruggiero & Perle, L.L.P, 10th Floor, One Landmark Square, Stamford, CT, 06901-2682, US

(73) Assignee: WINKLEVOSS TECHNOLOGIES, L.L.C., GREENWICH, CT

(21) Appl. No.: 10/225,853

(22) Filed: Aug. 22, 2002

(51) Int. Cl. G06F 17/60

(52) U.S. Cl. 705/35

(57) ABSTRACT

There is provided a method for facilitating an evaluation of a financial aspect of a retirement benefit plan. The method includes determining a set of incremental values between a lower limit value and an upper limit value of a variable relating to the retirement benefit plan, calculating a liability value for each member of the set of incremental values, thus yielding a set of liability values, and storing the set of liability values. The set of liability values is made accessible to an analyzer that receives a hypothetical value for the variable and, based on the hypothetical value, uses a member of the set of liability values to determine a hypothetical liability for the retirement benefit plan.

### BACKGROUND OF THE INVENTION

1. Field of the Invention

The present invention is directed to a method and system that allows a user, such as a financial professional or an executive of a corporation, to analyze financial aspects of an employer-sponsored pension plan and retiree health plan in an intuitive, rapid and cost-effective manner.

2. Description of the Prior Art

There are three types of retirement plans that are widely used to provide income to employees in retirement: 1) defined contribution plans (“DC plans”), 2) defined benefit plans (“DB plans”) and 3) retiree health plans (Other PostEmployment Benefits, or “OPEB plans”).

In a DC plan, the employer contributes an annual amount, generally defined as a fixed percentage of each employee's salary, into a tax-qualified trust. These contributions accumulate with investment earnings and provide a lump-sum at the employee's retirement. A popular version of a DC plan in the United States is known as a 401 (k) plan; however, there are other variations on this concept.

A DB plan, on the other hand, provides an employee with a specified (or defined) retirement benefit, the amount of which often depends on the employee's years of service and compensation at retirement. For example, a DB plan might provide one percent of the employee's final 5-year average pay for each year of service. If the employee works 30 years, for example, then this DB plan would provide 30 percent of the employee's final 5-year average salary as an annual pension benefit throughout retirement.

DB plans include so-called “hybrid” or cash balance plans. This version of a DB plan provides a notational account balance with respect to each employee, similar in many aspects to DC plans. The “accounts”, which are actuarially funded and converted to annual pension benefits, or paid as a lump-sum, often are calculated as a percentage of the employee's salary. The annual interest credited to the “accounts” is typically guaranteed by a pension trust and tied to a common financial index, such as the yield on 10-year US Treasury bonds.

In addition to the two “retirement income” plans, many employers also give retirees various OPEB plans, which provide certain medical coverage and other health-related benefits to retirees. These benefits may include health insurance, drug prescriptions and life insurance.

In the United States, an employer is responsible for funding a DB plan based on a complicated set of Federal statutes that requires budgeting, cash flow planning and trust fund deposits. Each year, the employer engages the services of an actuary to calculate the liability of the plan and then, by comparing this liability to assets accumulated in the pension trust, calculates the minimum required contribution and the maximum tax deductible contribution to the plan. If the employer makes the minimum contribution, then the plan will continue to be “qualified”; i.e., the plan will qualify for tax treatment as a DB plan, and, hence, the employer can take a tax deduction for contributions, and investment earnings on plan assets in the pension trust accumulate without taxation. Moreover, DB plan accounting expense pursuant to Financial Accounting Statement 87 (“FAS87”), promulgated by the Financial Accounting Standards Board, requires planning, projections and plan valuations because a DB plan's impact on a corporate balance sheet and earnings can be material. This is in contrast to a DC plan's expense, which is a known quantity each year.

The calculation of contribution limits and FAS87 accounting expense by the actuary is a laborious effort. Each employee is considered, one by one, and calculations are made to estimate the employee's future salary, whether the employee will reach retirement or terminate employment prior to becoming eligible to retire, the age at which the employee might retire, the expected investment earnings on contributions made to the plan prior to the employee's retirement, and so forth. This calculation process is called an actuarial valuation and is required annually.

Because of the complicated nature of actuarial valuations, and the many associated assumptions involved, it is not possible for an employer to know with certainty what next year's minimum required contribution will be until the valuation is complete, which could be four to six months after the plan's year-end. Moreover, there are a number of events that could significantly affect the year-to-year contributions to the plan that are difficult to anticipate. For example, a downturn in capital markets, like those that occurred in 2000 and 2001, can significantly increase minimum contribution requirements, depending on the plan's funded status prior to the downturn. Similarly, a decrease in market interest rates can dramatically increase employer contributions and vice versa, because the valuation process uses interest rate assumptions to reflect future investment earnings and this is an important component in determining costs. To make matters even more complicated, Federal statutes require three different interest rate assumptions to be used in the valuation; one when the plan is near 100 percent funded or over-funded, and another two that apply when the plan's funded status falls below certain levels.

In addition to valuations that determine the contribution limits, the actuary must determine the financial accounting, or FAS87 expense, for the plan. Not only are the financial accounting calculations different than those for determining contributions, but some of the important assumptions are different as well. For example, pension accounting requires two interest rate assumptions, which are generally different from the three interest rate assumptions used in determining contributions. A corporation's fiscal year-end often creates significant timing problems for producing financial accounting valuations for disclosure and annual reports. The four to six months traditionally required after fiscal year-end for the laborious calculation process to be completed is not acceptable for many companies. Often, estimates and compromises in the calculation process are made in order to meet such time pressures.

The complexities associated with DB plans make them very difficult for corporate executives to manage. Executives often feel they lack sufficient understanding of, and control over, their DB plans, with little ability to anticipate what might happen to next year's contribution and/or accounting expense, thereby providing little opportunity to put policies in place that might mitigate significant surprises. This position can create problems for corporate cash flow, investors (in terms of the impact on earnings), and employees who expect retirement income security. In fact, many smaller corporations have terminated their DB plans in favor of DC plans, where the annual expense is a known quantity each year. Most large companies, however, continue to maintain DB plans.

Almost identical sets of problems exist for OPEB plans. While these plans do not have to be funded like DB plans, some corporations have elected to begin funding the associated liability. Moreover, the accounting profession has promulgated FAS106, which is similar to FAS87 for DB plans, requiring corporations to evaluate these liabilities and disclose them in their financial statements. Again, timeliness and expense are issues with these plans because of the laborious nature of the required calculations.

Traditional actuarial valuations of retirement benefit plans require a laborious set of calculations. If the plan sponsor, for example, wanted to know what the financial implications might be if one of the interest rates were decreased by one percentage point, it might take the actuary several weeks and several thousands of dollars to provide the answer. Because there are three interest rates associated with pension calculations for determining contributions and another two for determining FAS87 expense, it would be difficult, and undoubtedly quite expensive, for the actuary to generate the financial implications associated with both individual and simultaneous changes in such rates.

### SUMMARY OF THE INVENTION

The present invention is directed toward an analysis of DB plans and OPEB plans (together, “retirement benefit plans”). It is designed to give corporate executives a comprehensive analysis of their retirement benefit plans in terms of contributions and accounting expense under a variety of assumptions, all in a relatively short time, such as a few seconds or minutes.

The present invention shows implications on contributions and accounting expense for the current year under a variety of different assumptions, and also shows the trend in costs over future years under both deterministic and stochastic assumptions. It handles all complexities of these projections, including alternative economic trials and asset mixes, Federal statutes and regulations with respect to plan funding and various accounting standards. It performs thousands of calculations, and presents results simply and graphically to executives and their colleagues. There is a minimum of concise input variables displayed and manipulated easily, such that an executive can use this invention either alone or in collaboration with advisors to anticipate and mitigate adverse future cash flow or accounting impacts that their plans might generate.

The present invention provides a method for facilitating an evaluation of the financial aspects of a retirement benefit plan. The method includes determining a set of incremental values between a lower limit value and an upper limit value of a variable, i.e., various parameters and assumptions, calculating the liabilities associated with the various incremental values, and storing the results. The set of liability values is made accessible to an analyzer that receives a hypothetical value for a parameter or assumption and, based on the hypothetical value, uses a member of the set of liability values, or interpolates between two values, to determine a hypothetical liability, and ultimately a contribution and accounting expense, for the retirement benefit plan.

### BRIEF DESCRIPTION OF THE DRAWINGS

FIG. 1 is a block flow diagram of a process for developing a plan liabilities matrix for use in an actuarial valuation of a retirement benefit plan.

FIG. 2 is a block flow diagram of a retirement benefit plan analyzer for an actuarial valuation of a retirement benefit plan.

FIG. 3 is an illustration of a user interface for the analyzer of FIG. 2.

FIG. 4 is a block flow diagram of a process for developing a benefit payments and liabilities matrix for use in a deterministic projection of a retirement benefit plan.

FIG. 5 is a block flow diagram of a retirement benefits plan analyzer for a deterministic projection of a retirement benefit plan.

FIG. 6 is an illustration of a user interface for the analyzer of FIG. 5.

FIG. 7 is a block flow diagram of a process for developing a benefit payments and liabilities matrix for use in a stochastic projection of a retirement benefit plan.

FIG. 8 is a block flow diagram of a retirement benefits plan analyzer for a stochastic projection of a retirement benefit plan.

FIG. 9 is an illustration of a user interface for the analyzer of FIG. 7.

FIG. 10 is a block diagram of a computer system suitably configured for employment of the present invention.

### DESCRIPTION OF THE INVENTION

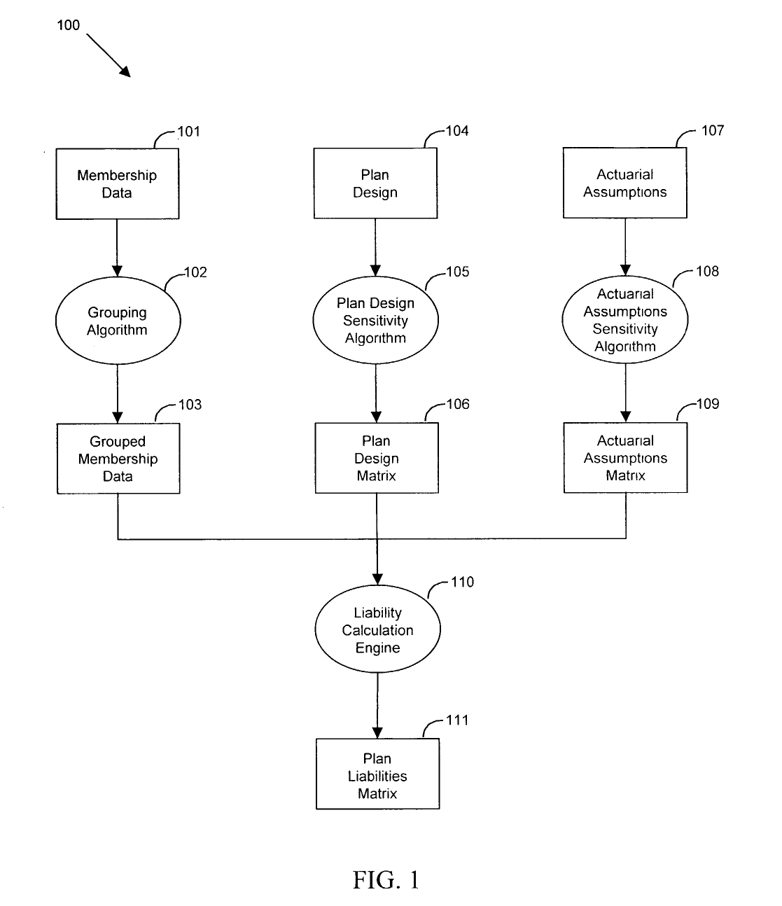

FIG. 1 is a block flow diagram of a process 100 for developing a plan liabilities matrix 111, in accordance with the present invention, for use in an actuarial valuation of a retirement benefit plan, such as a DB plan or OPEB plan. The components of process 100 include membership data 101, a grouping algorithm 102, grouped membership data 103, a plan design 104, a plan design sensitivity algorithm 105, a plan design matrix 106, actuarial assumptions 107, an actuarial assumptions sensitivity algorithm 108, an actuarial assumptions matrix 109, and a liability calculation engine 110. Process 100 would typically be performed by a technical user, such as an actuary, and its purpose is to populate plan liability matrix 111 with the results of many liability calculations under a large number of different plan designs 104 and actuarial assumptions 107.

Membership data 101 include such items as each employee's birth date, hire date, gender, salary history and other relevant information for calculating the benefits and associated liabilities for both active and non-active employees (i.e., retirement benefit plan members).

Grouping algorithm 102 performs a grouping task to organize membership data 101 into groups of members with similar age, service, gender and salary, thus yielding grouped membership data 103. A user specifies a variable to be used in grouping algorithm 102 and the span of each grouping. For example, one user might specify that members be grouped by 5-year age brackets and 5-year service periods, while another user might specify a 3-year span between breakpoints, e.g., all employees with ages 20, 21 and 22, and who have worked one, two or three years, might be grouped and assigned an average age of 21 and an average service period of two years. The purpose of grouping the membership into cells is to expedite the calculation of the liabilities associated with each variation in plan design 104 and actuarial assumptions 107. For example, calculating the liabilities associated with 1,000 grouped cells is ten times faster than performing the same calculations on a member-by-member basis when the membership consists of 10,000 employees.

Plan design 104 includes all of the relevant information needed to determine the amount of benefits payable under the plan and when such benefits are payable for each plan member. In a DB plan, for example, the plan design would include the percent of salary provided for each year of service, the length of the salary averaging period (if, for example, the benefit formula uses the employee's “final average salary” in determining benefits), any maximums in terms of salary or service that are applicable, the “payment form” of the benefit (i.e., whether it is payable for the life of the retiree or payable for the life of both the retiree and spouse), and any other information needed to precisely determine the benefits payable under the plan. For example, if a DB plan were to provide 1.5 percent of an employee's highest 5-year average salary for each year of service, then plan design 102 would include the 1.5 percent component and a parameter indicating the highest 5-year salary average is used in a calculation of the benefits. There are a host of other elements that can make up either a DB plan or OPEB plan design, such as when a member is eligible for various benefits at retirement, disability, termination and death, and information for determining a precise benefit in each case.

Plan design sensitivity algorithm 105 determines variations in the plan design for populating plan design matrix 106. More specifically, plan design sensitivity algorithm 105 calculates a set of incremental values between a lower limit value and an upper limit value of an assumption parameter from plan design 104. For example, if the plan benefit formula provided 1.5% of salary per year of service, the sensitivity algorithm might generate plan designs percentages of 1%, 1.1%, 1.2% and so forth up to 2.0% and place these parameters in plan design matrix 106. If the “final average salary” for the plan were five years, for example, the plan design sensitivity algorithm might generate four or five different “salary averaging periods” to be placed into plan design matrix 106. In fact, plan design sensitivity algorithm 105 would systematically generate variations in all of the relevant plan design parameters and place the results into plan design matrix 106.

Actuarial assumptions 107 are all of the parameters needed to calculate the liabilities of a DC or OPEB plan. Actuarial assumptions 107 include (a) various interest rates for determining a present value of a future benefit, (b) salary assumptions for estimating an active member's future salary, (c) decrement assumptions, such as retirement rates, termination rate, disability rates and death rates, used to estimate if and when a benefit might become payable, and any other assumption needed to properly calculate the plan's liabilities.

Actuarial assumptions sensitivity algorithm 108 takes each of the actuarial assumptions 107 and determines a set of incremental or interim values of these parameters over a relevant range, from a lower limit value to an upper limit value. The incremental or interim values are then stored in actuarial assumptions matrix 109. For example, for each of the five interest rates used in DB plans (three for determining contributions and two for determining FAS87 accounting expense), actuarial assumptions sensitivity algorithm 108 might place 20 interest rates in actuarial assumptions matrix 109 for each of the five assumptions (e.g., 1%, 2%, . . . 20%). Some assumptions, such as the rate of inflation used to project employee salaries, might be varied in conjunction with other assumptions. For example, the inflation rate may also span from 1% to 20%, however, since inflation and interest rates in general are linked, it is not necessary to consider all twenty inflation rates for each of the twenty interest rates (e.g., an inflation rate of 1% and an interest rate of 20% is unrealistic). Therefore, for each interest rate, generating an inflation rate of plus or minus 5%, for example, might be sufficient.

Actuarial assumptions matrix 109 is a stored version of the results from actuarial assumptions sensitivity algorithm 108. Actuarial assumptions matrix 109 may consist of many entries, depending on the number of actuarial assumptions upon which sensitivities are based and the gradation between values. Table 1 shows a partial view of the actuarial assumptions matrix 109. In this case, the initial set of actuarial assumptions associated with the plan are indicated by the term “baseline” in the first row. A1 represents the first actuarial assumption, A2 the second, and so forth through An, which represents the n^{th} actuarial assumption. Two interest rates, Rate 1 and Rate 2, are indicated in the table. Each of these rates is altered from 1% through 20% to illustrate the various sensitivities that might be run.

Liability calculation engine 110 uses grouped membership data 103, plan design matrix 106 and actuarial assumptions matrix 109 to calculate a set of plan liability values. Liability calculation engine 110 is a conventional actuarial valuation model widely available throughout the DB and OPEB industry. A liability value, for this purpose, is a financial number that represents a current (or present) value of future benefit payments to plan participants. In theory, if funds were on hand in the amount of this liability, and if such funds were to earn an investment return equal to an interest rate assumed in determining the present value, then such funds would be sufficient to pay all future benefits under the plan. Liability calculation engine 110 performs an actuarial valuation for each set of assumptions in plan design matrix 106 and each set of assumptions in actuarial assumptions matrix 109. This process can take a long time (e.g., days) even with the fast computers currently available due to the large number of actuarial valuations required.

TABLE 1
Actuarial Assumptions Matrix 109

| | | | | Rate 1 | Rate 2 | | |
|---|---|---|---|---|---|---|---|
| Baseline | A1 | A2 | A3 | 6% | 5% | . . . | An |
| 1 | A1 | A2 | A3 | 1% | 5% | . . . | An |
| 2 | A1 | A2 | A3 | 2% | 5% | . . . | An |
| 3 | A1 | A2 | A3 | 3% | 5% | . . . | An |
| 4 | A1 | A2 | A3 | 4% | 5% | . . . | An |
| 5 | A1 | A2 | A3 | 5% | 5% | . . . | An |
| 6 | A1 | A2 | A3 | 7% | 5% | . . . | An |
| . . . | . . . | . . . | . . . | . . . | . . . | . . . | . . . |
| 19 | A1 | A2 | A3 | 20% | 5% | . . . | An |
| 20 | A1 | A2 | A3 | 6% | 1% | . . . | An |
| 21 | A2 | A2 | A3 | 6% | 2% | . . . | An |
| 22 | A1 | A2 | A3 | 6% | 3% | . . . | An |
| 23 | A1 | A2 | A3 | 6% | 4% | . . . | An |
| 24 | A1 | A2 | A3 | 6% | 6% | . . . | An |
| . . . | . . . | . . . | . . . | . . . | . . . | . . . | . . . |
| 38 | A2 | A2 | A3 | 6% | 20% | . . . | An |
| . . . | . . . | . . . | . . . | . . . | . . . | . . . | . . . |

Plan liabilities matrix 111 is a stored version of the liability values calculated by liability calculation engine 110. Plan liabilities matrix 111 has as many liability values as the number of valuations performed on the various elements in plan design matrix 106 and actuarial assumptions matrix 109, which could total in the hundreds.

As explained below, plan liabilities matrix 111 is used by a retirement benefits analyzer. Note that in a preferred embodiment of the present invention, process 100 is executed prior to execution of the retirement benefit analyzer. Thus, plan liabilities matrix 111 is pre-constructed, and is readily available when the retirement benefit analyzer is executed.

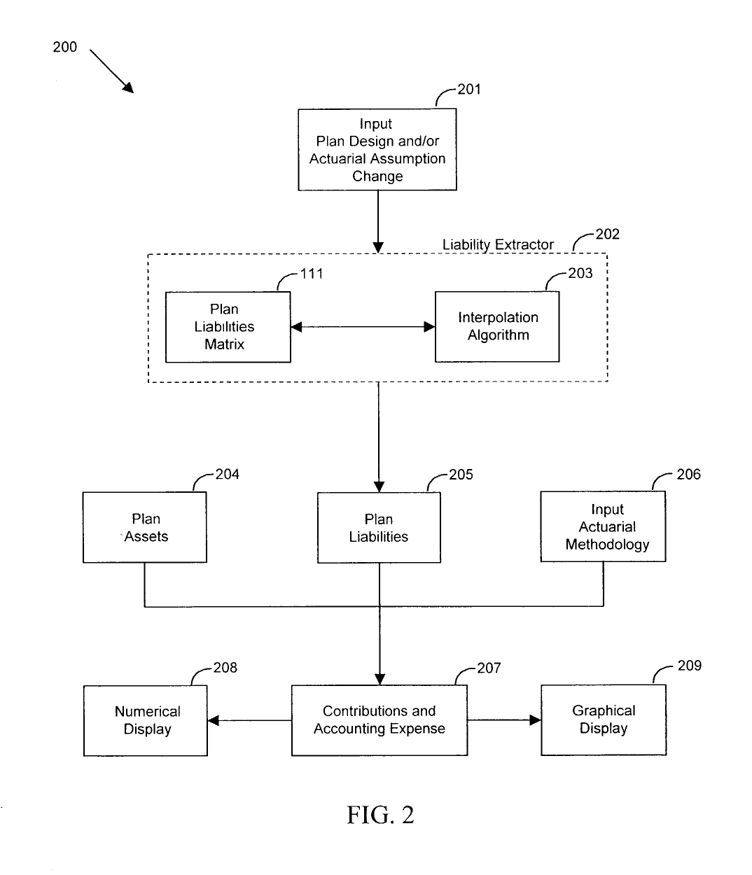

FIG. 2 is a block flow diagram of a retirement benefit plan analyzer 200. Analyzer 200 performs an actuarial valuation of the retirement benefit plan and provides a user with the answers to questions about the financial implications of plan benefit and actuarial assumption changes. Because all of the liability calculations have been perform in process 100, the answers to such changes are provided nearly instantaneously. The principal components of analyzer 200 are an input plan design and/or actuarial assumption change 201, a liability extractor 202, plan assets 204, plan liabilities 205, actuarial methodology 206 and contributions and accounting expense 207. Note that liability extractor 202 accesses plan liabilities matrix 111.

Input plan design and/or actuarial assumption change 201 allows the user to initiate a change in an input (e.g., a change in one of the five interest rates from, say, 5% to 6%). Input change 201 thus provides a hypothetical value for a parameter relating to a retirement benefit plan. This change is fed into liability extractor 202.

Liability extractor 202 receives the input change 201 and determines plan liabilities 205. Liability extractor 202 determines the appropriate plan liabilities 205 by first examining whether the input change 201 is included in plan design matrix 106 or actuarial assumptions matrix 109 (see FIG. 1). If the input change is included, then the exact plan liabilities are available from plan liabilities matrix 111. Accordingly, liability extractor 202 retrieves the appropriate liability data from plan liabilities matrix 111.

If the input change is not included in plan design matrix 106 or actuarial assumptions matrix 109, then liability extractor 202 uses an interpolation algorithm 203 to approximate the plan liabilities. Accuracy of the interpolation is dependent on the number of liability values in plan liability matrix 111, which, in turn, is determined by the number of variations in plan design matrix 106 and actuarial assumptions matrix 109.

Plan assets 204 represents the accumulated trust funds associated with the DB pension plan or OPEB plan. The value of plan assets 204 might represent the market value of such assets or, more likely, a market-related value, such as a three-year moving average of market values.

Plan liabilities 205 stores the liabilities as determined by liability extractor 202.

Actuarial methodology 206 includes a cost method used in funding the plan and amortization procedures used in funding unfunded liabilities. There are two generic types of cost methods, namely the “entry age normal” method and a the “unit credit” method.

The entry age normal method calculates a level percentage of pay from a participant's entry age to retirement age that is expected to fully fund the plan's benefit. There are several variations of this generic funding method.

The unit credit method calculates an amount that will fund a current year's benefit accrual. When these accrual costs are expressed as a percentage of an employee's salary, they start out as low percentages at the employee's entry age, and become higher percentages with each successive year. This pattern is in contrast to the entry age normal methodology that generates a level percentage of pay cost structure. Again, there are several variations of this generic funding method as well.

Actuarial methodology 206 also determines how any unfunded liabilities are to be amortized. For example, if liabilities are $100 million and assets are $75 million, the cost method might account for contributing $15 million in future years with a remaining $10 million being amortized over, say, 15 years. This amortization calculation is similar to calculating an amortization of a house mortgage, for example, where each annual payment represents both principal payback and interest on an outstanding balance.

Actuarial methodology 206 allows the user to specify the actuarial methodology used in process 200. For example, the user may wish to examine the financial impact of switching from one of the entry age normal funding methods to one of the unit credit funding methods, or to change the amortization period for funding unfunded liabilities from 15 years to 10 years, for example.

Analyzer 200 uses plan assets 204, plan liabilities 205 and actuarial methodology 206 to calculate the contributions and accounting expense 207 associated with the DB pension plan or OPEB plan. For example, if a plan's current contributions and accounting expense are $10 million and $15 million, respectively, analyzer of 200 might show that if the interest rates used in these calculations were increased by one percentage point, then contributions and accounting expense might be reduced to $8 million and $12 million, respectively.

Contributions and accounting expense 207 stores the contributions and accounting expense calculated by analyzer 200. Analyzer 200 presents contribution and accounting expense 207 in either of a numerical display 208 or a graphical display 209.

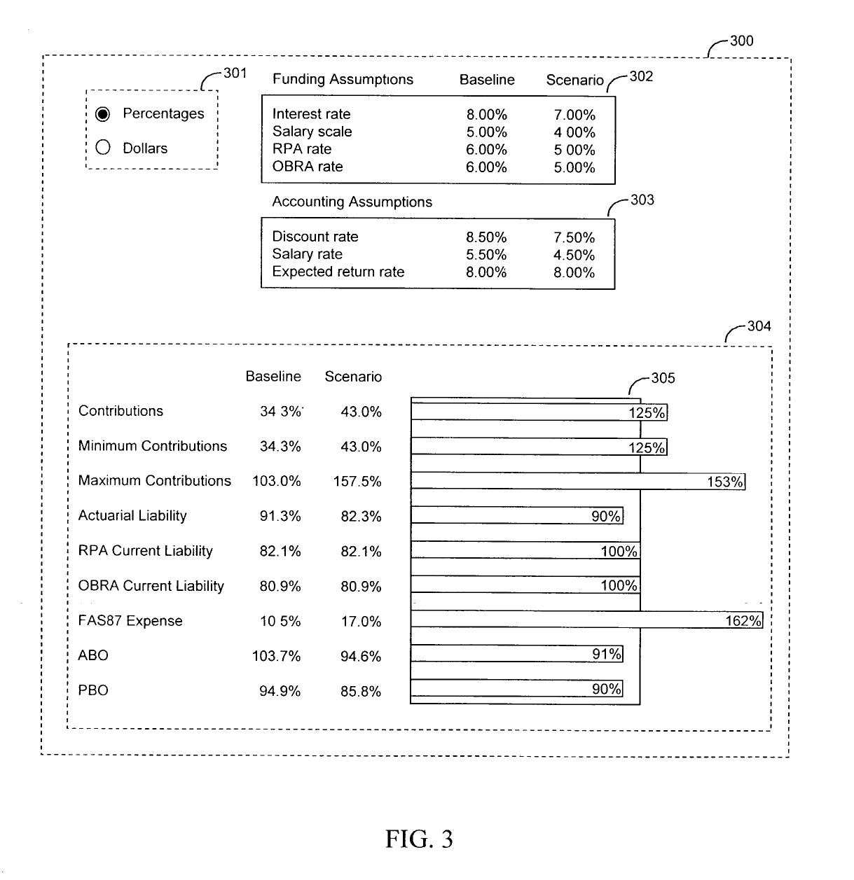

FIG. 3 is an illustration of an exemplary user interface 300, e.g., a video display, of analyzer 200 being used for a DB pension valuation. The user can alter interest and salary rate assumptions, and immediately see a financial result of such alterations, both numerically and graphically. With a selector 301, the user selects whether the results are to be displayed as percentages (e.g., costs as a percentage of salary, or assets as a percentage of liabilities) or as dollar amounts. In this example, “Percentages” is selected. Various interest and salary rates are segregated into funding assumptions 302 and accounting assumptions 303. Funding assumptions 302 are used in determining contributions, while accounting assumptions 303 are used in determining accounting expense. Funding assumptions 302 and accounting assumptions 303 have a baseline column and a scenario column. The rates listed in the baseline column are those used in a most recent actuarial valuation. The rates listed in the scenario column are those entered by the user. In this example, the user has entered scenario rates that are one percentage point lower than the baseline rates.

When the user makes each rate change, the result of each scenario entry is shown in a section 304, which includes a graphical depiction of the result in a bar chart 305. The output in section 304 is also organized, again, under baseline and scenario columns. Additionally, bar chart 305 shows, visually, how much the scenario values have been changed from the baseline values. For example, FAS87 expense increased from a baseline value of 10.5% of salary to a scenario value of 17.0%, due to the various assumption changes. Similarly, a PBO funded ratio decreased from 94.9% to 85.8% in this example.

Although FIG. 3 shows an example of a case analyzing implications of various interest and salary rates on annual valuation results of a DB plan, the same process can be applied to virtually any plan design or actuarial assumption change associated with a DB plan or OPEB plan.

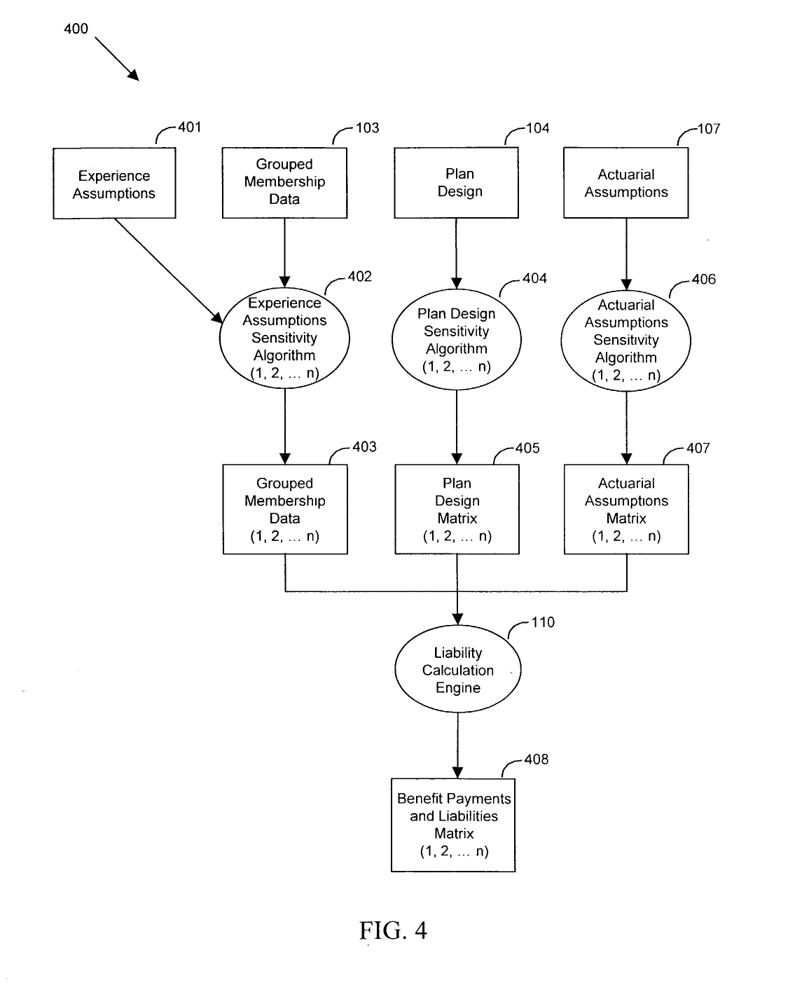

FIG. 4 is a block flow diagram of a process 400 for developing a benefit payments and liabilities matrix 408 for use in a deterministic projection of a DB pension plan or OPEB plan. A deterministic projection is a financial forecast created by performing actuarial valuations on future estimates of membership data.

Experience assumptions 401 represent all of the assumptions required to simulate future grouped membership data 403. These assumptions include termination rates, disability rates, retirement rates and death rates for the membership. In addition, the growth or decline in total membership is also a component of experience assumptions 401.

Experience assumptions 401 are fed into an experience assumptions sensitivity algorithm 402 to produce a unique set of experience assumptions that are applied to group membership data 103 (see FIG. 1). This application produces an n-year projection of grouped membership data 103, the results of which are stored in group membership data 403 and which includes grouped membership data for each of the n-years in the projection period. This process is repeated, with the experience assumptions sensitivity algorithm 402 generating variations in the experience assumptions 401. For example, experience assumptions sensitivity algorithm 402 might generate five different future population growth assumptions, such as from −4%, −2%, 0%, +2% and +4%, which would ultimately allow the user to investigate the financial implications of different future membership growth rates. The results stored in the grouped membership data 403 represent a huge amount of data. For example, it contains grouped membership data for each year of the projection (1, 2, . . . n) and for each set of experience assumptions generated by experience assumptions sensitivity algorithm 402.

Plan design 104 and actuarial assumptions 107 are identical to those used in process 100 (FIG. 1). The sensitivity algorithms applied to each, however, have an n-year dimension, i.e., a temporal dimension, associated with them. As an example, a plan design sensitivity algorithm 404 might produce future plan benefits that increase over time for inflation. Similarly, an actuarial assumptions sensitivity algorithm 406 might produce a series of interest rates that increase (or decrease) over the n-year period. Nevertheless, each of sensitivity algorithms 402, 404 and 406 determine a set of incremental values between a lower limit value and an upper limit value of a variable, i.e., a parameter or assumption, relating to the retirement benefit plan under consideration.

Process 400 produces benefit payments and liabilities matrix 408 by taking grouped membership data 403, plan design matrix 405 and actuarial assumptions matrix 407 and feeding these sets of data into liability calculation engine 110. This is the same engine used in FIG. 1; however, in this instance it is applied along an n-year dimension.

As explained below, plan benefits and liabilities matrix 408 is used in a retirement benefit plan analyzer. Note that in a preferred embodiment of the present invention, process 400 is executed prior to execution of the retirement benefit analyzer. Thus, plan benefits and liabilities matrix 408 is pre-constructed, and is readily available when the retirement benefit analyzer is executed.

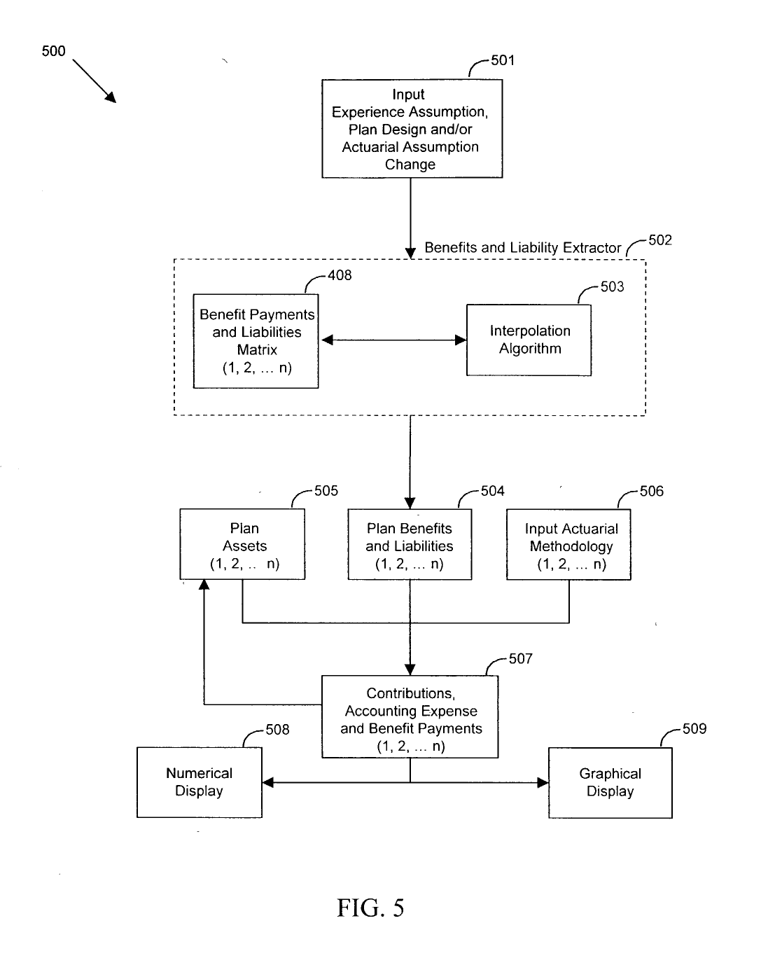

FIG. 5 is a block flow diagram of a retirement benefits plan analyzer 500 for a deterministic projection of a retirement benefit plan. Analyzer 500 operates in a manner similar to that of analyzer 200, shown in FIG. 2. A user inputs an experience assumption, plan design and/or actuarial assumptions change 501, thus providing a hypothetical value for a parameter relating to a retirement benefit plan. A benefits and liability extractor 502 receives this input change and determines plan benefits and liabilities 504 by either using the exact values from the benefit payments and liabilities matrix 408, if they exist, or by using an interpolation algorithm 503 if they do not exist.

Contributions, accounting expense and benefit payments 507 is determined for each of the n-years by referencing an appropriate year's plan assets 505 and actuarial methodology 506 in combination with plan benefits and liabilities 504. Each year, however, plan assets 505 must be adjusted upward for contributions made to the plan in a prior year plus investment earnings on existing trust fund assets and adjusted downward for benefit payments.

An output from deterministic projection 500 is made available to the user, in a matter of seconds, and presented in both a numerical display 508 and a graphical display 509.

Analyzer 500 permits the user to postulate a specific future environment. For example, if inflation increases from 3 to 5 percent over the next 10 years, and investment earnings decrease from 10 to 5 percent over the same period, the invention can quickly estimate what will happen to contributions, accounting expense and benefit payments 507. A deterministic projection shows financial data in each future year, allowing the user to better understand the financial risk associated with the plan. The invention allows corporations to investigate such deterministic scenarios in a matter of seconds. This is in sharp contrast to prior art practices, where such information may take several weeks and thousands of dollars.

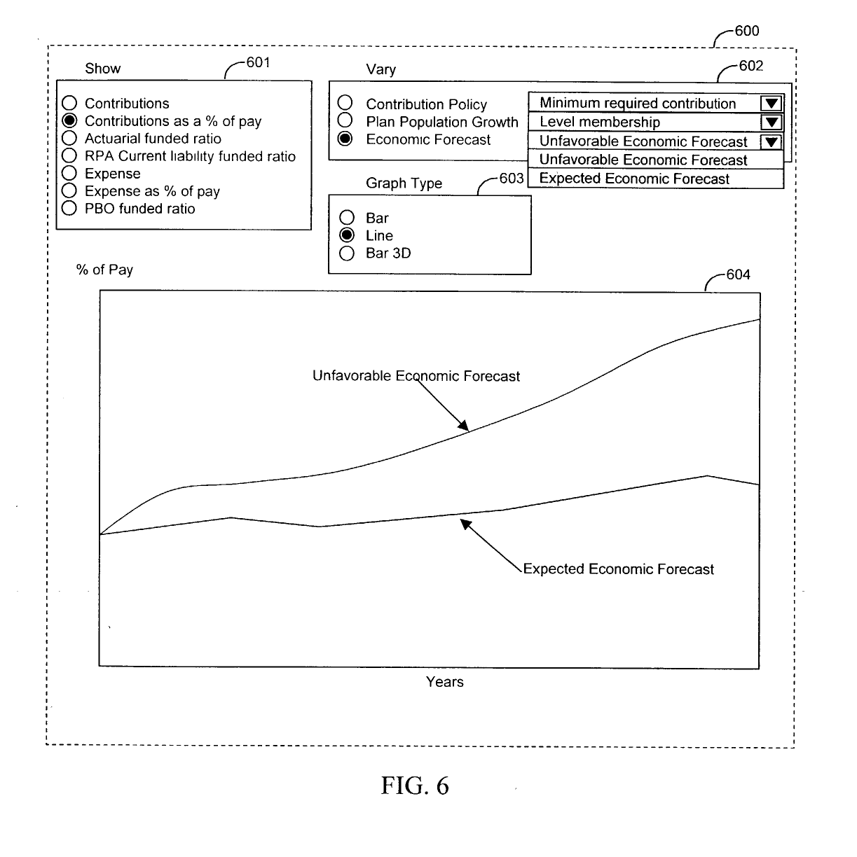

FIG. 6 is an illustration of an exemplary user interface 600, e.g., a video display, for analyzer 500. A selector 601 allows a user to select a financial statistic, this example showing seven such financial statistics. In this example, a selector 602 allows the user to vary one of three items: a) contributions policy, b) plan population growth and c) economic forecast. In this instance, the user has selected to vary the economic forecast, for which two projection assumptions are shown (unfavorable economic forecast and expected economic forecast). The other two items are locked into the scenarios shown (i.e., “contribution policy” is set at “minimum required contributions” and “plan population growth” is set to “level membership”). A selector 603 allows the user to select from three different types of graphs. The results are shown in a graph 604.

The present invention also contemplates a retirement benefit plan analyzer that shows results of a stochastic projection. A stochastic projection can be conceptualized as a large group of deterministic projections where each deterministic projection represents results of a slightly different scenario, the slight difference coming about through a random variable being applied to a projection variable in question. One use of stochastic projections is to study the financial impact of assets being invested in stocks and bonds, for example, where the future years' returns all have the same expected value but differ due to random deviations from the expected value. Typically, a stochastic, or Monte Carlo, simulation will involve several thousand n-year trials of investment returns to which the plan is exposed. Plan sponsors use stochastic projections not only to study financial implications of a given asset mix, e.g., 60 percent stocks and 40 percent bonds, but alternative asset mixes, such as varying the stock percentage from zero percent to 100 percent in increments of 20 percent, in order to establish an asset mix of the plan. There are, of course, many other experimental designs that can be explored by using stochastic projections, such as the financial impact of alternative growth rates in active membership of the plan or the incidence of different decrements from the plan (i.e., terminations, disabilities, deaths and/or retirements).

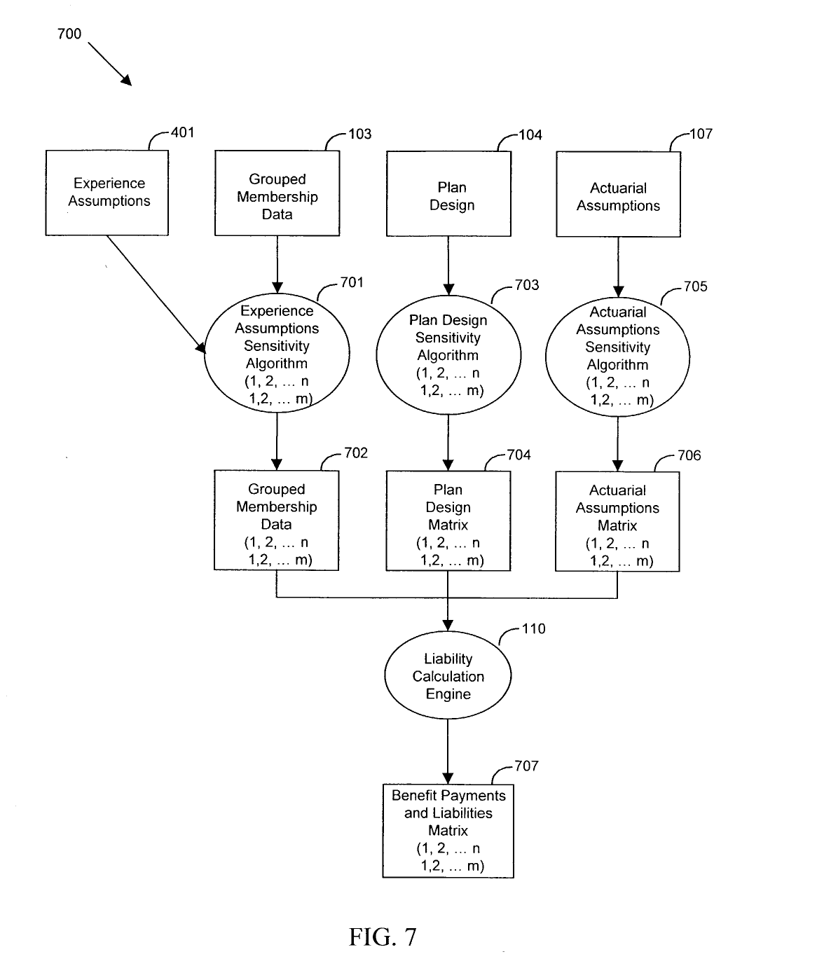

FIG. 7 is a block flow diagram of a process 700 for developing a benefit payments and liabilities matrix 707 for use in a stochastic projection of a DB pension plan or OPEB plan. Process 700 is similar to process 400, and sensitivity algorithms 701, 703 and 705 are similar to sensitivity algorithms 402, 404 and 406, respectively, except that sensitivity algorithms 701, 703 and 705 have a second dimension representing trials associated with a stochastic projection. As a result grouped membership data 702, plan design matrix 704 and actuarial assumptions matrix 706 also have a trials dimension. These matrices are very large, since the number of trials should be several thousand.

Liability calculation engine 110 is the same actuarial valuation model used in FIG. 1 and FIG. 4. Benefit payments and liabilities matrix 707 is also quite large since it too reflects the trials dimension of the stochastic projection.

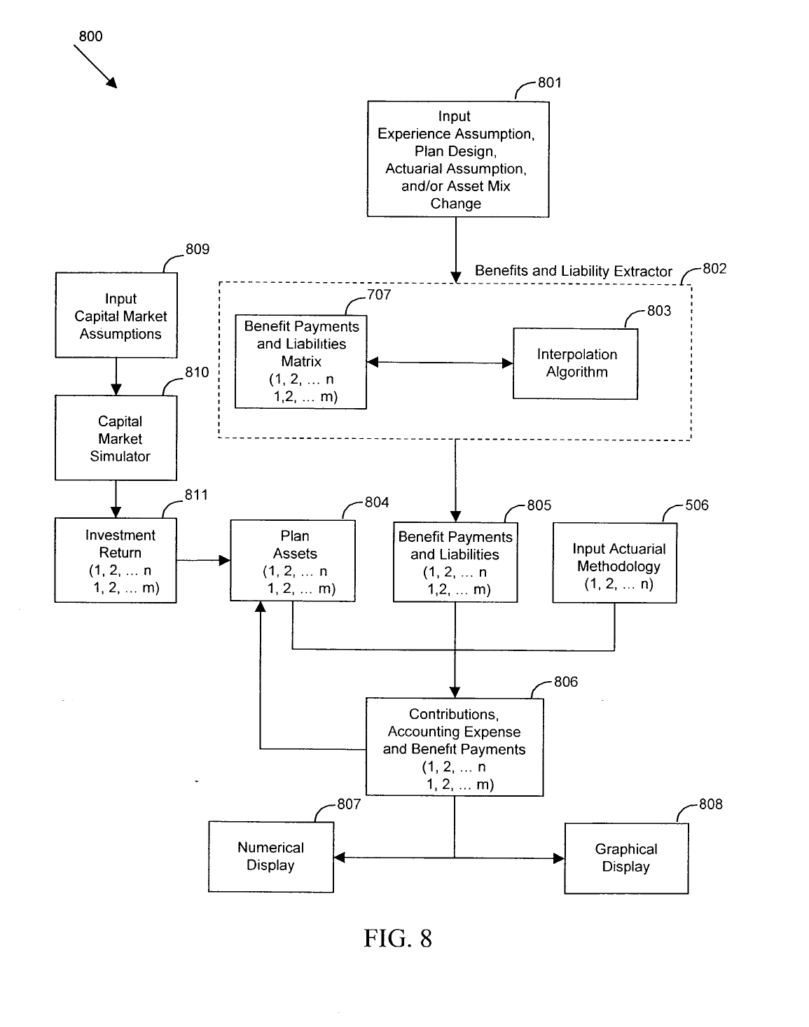

FIG. 8 is a block flow diagram of a retirement benefits plan analyzer 800 for a stochastic projection of a retirement benefit plan. Analyzer 800 operates in a manner similar to that of analyzer 500, shown in FIG. 5. A user inputs a change in experience assumptions, plan design, actuarial assumptions or asset mix 801, thus providing a hypothetical value for a variable relating to the retirement benefit plan. A benefits and liability extractor 802 receives this input change and determines plan benefits and liabilities 805 by either finding the exact values from the benefit payments and liabilities matrix 707 or by using an interpolation algorithm 803.

Stochastic projections are often used to examine the effects of capital market simulations in conjunction with various asset mixes on the investment return of the plan assets in the trust fund, which ultimately affect contributions and accounting expense. Therefore, analyzer 800 includes input capital market assumptions 809, a capital market simulator 810 and investment return 811. The investment return 812 has both an n-year and m-trial dimension.

Plan assets 804, benefit payments and liabilities 805 and actuarial methodology 506 are used to determine contributions, accounting expense and benefit payments 806. An output can be shown on a numerical display 807 or a graphical display 808.

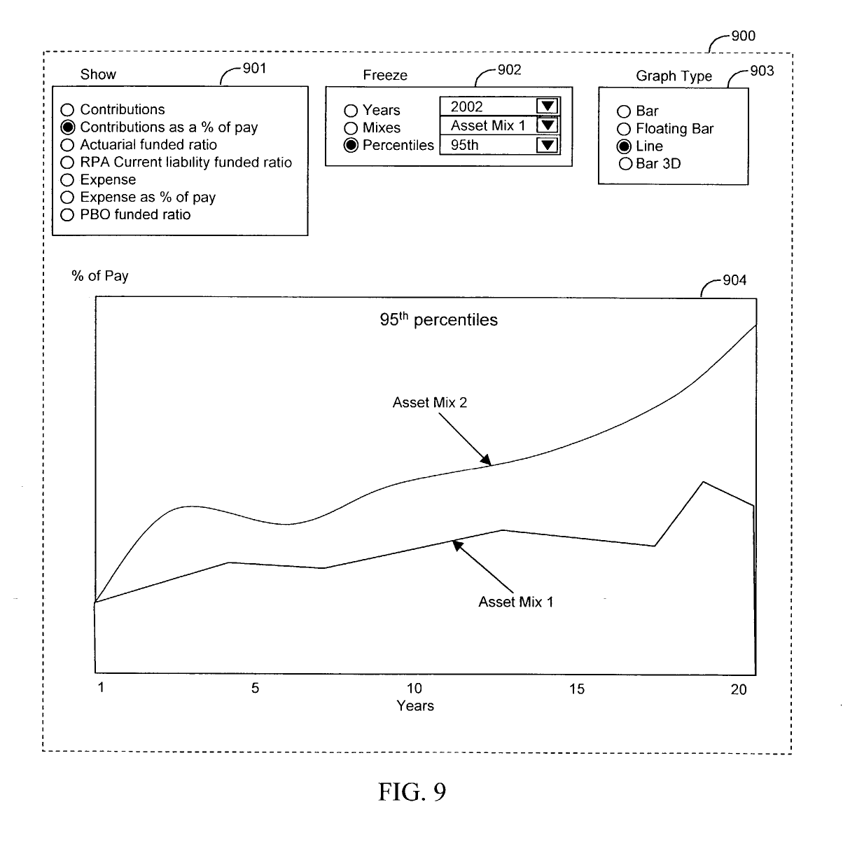

FIG. 9 is an illustration of an exemplary user interface 900, e.g., a display, for analyzer 800. Similarly to display 600, as shown in FIG. 6, a selector 901 allows the user to select one of a set of financial variables. With a selector 902, the user can select to freeze one of the three dimensions (year, mix or percentile). In this example, the output shows all years and all mixes, but only the 95^{th} percentile of results because the percentile dimension is selected to be frozen. An output graph 904 shows that there are 20 years and two asset mixes in the analysis, labeled Asset Mix 1 and Asset Mix 2. Analyzer 900 is a tool that can show a plan sponsor, nearly instantaneously, projection data that prior art techniques typically require many weeks and many thousands of dollars to develop.

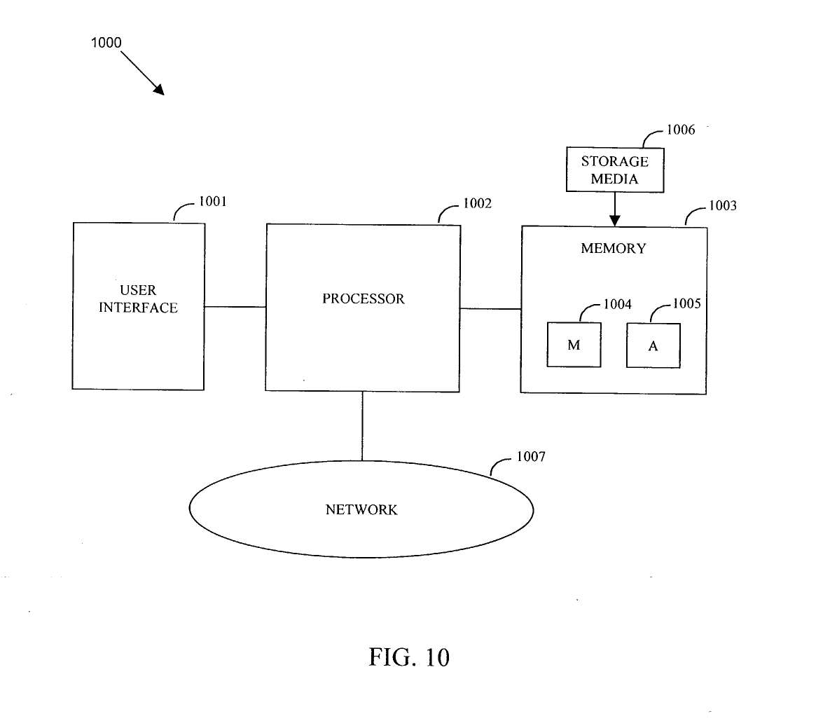

FIG. 10 is a block diagram of a computer system 1000 suitably configured for employment of the present invention. System 1000 includes a user interface 1001, a processor 1002 and a memory 1003.

User interface 1001 represents a collection of equipment that allows a user to provide input to, and receive output from, system 1000. Such equipment may include, for example, a keyboard, a speech recognition/generation subsystem, a display, a mouse, and a printer.

Processor 1002 may be implemented on a general-purpose microcomputer, such as one of the members of the Sun™ Microsystems family of computer systems, one of the members of the IBM™ Personal Computer family, or any conventional workstation or graphics computer device.

Memory 1003 stores data and instructions for controlling the operation of processor 1002, and more specifically, program modules 1004 and 1005. Program module 1004 contains instructions for controlling processor 1002 to execute process 100 to construct plan liabilities matrix 111, to execute process 400 to construct plan benefits and liabilities matrix 408, and to execute process 700 to construct benefit payments and liabilities matrix 707. Program module 1005 contains instructions for controlling processor 1002 to execute analyzers 200, 500 and 800. Memory 1003 may be configured to include a read only memory (ROM), a hard drive and a random access memory (RAM), none of which are specifically shown in FIG. 10 While the procedures required to execute the invention are indicated as already loaded into memory 1003, they may be configured on a storage media 1006 for subsequent loading into memory 1003. Storage media 1006 can be any conventional storage media such as a magnetic tape, an optical storage media, a compact disk, or a floppy disk. Alternatively, storage media 1006 can be a random access memory, or other type of electronic storage, located on a remote storage system.

Although system 1000 is represented herein as a standalone system, it is not limited to such, but instead can be part of a networked system and coupled to another device (not shown), such as a workstation, via a network 1007. As such, system 1000 can act as a server to the workstation where the workstation accesses program modules 1004 and 1005. Network 1007 can be configured as any conventional network such as a local area network (LAN), a wide area network (WAN), an intranet, or the Internet.

In the context of the present invention an analyzer performs a valuation of a retirement benefit plan using a hypothetical value for a parameter. In turn, one result of the valuation is a hypothetical liability. The hypothetical value is a supposed or assumed value for purpose of test or evaluation. However, although the value of the parameter and the liability are described herein as being hypothetical, the present invention is contemplated as also covering a situation where the parameter of interest actually takes on the value that was regarded as hypothetical for purpose of evaluation. Accordingly, it should be understood that various alternatives and modifications of the present invention could be devised by those skilled in the art. Nevertheless, the present invention is intended to embrace all such alternatives, modifications and variances that fall within the scope of the appended claims.

What is claimed is:

1. A method for facilitating an evaluation of a financial aspect of a retirement benefit plan, comprising:
determining a set of incremental values between a lower limit value and an upper limit value of a variable relating to said retirement benefit plan;
calculating a liability value for each member of said set of incremental values, thus yielding a set of liability values; and
storing said set of liability values,
wherein said set of liability values is made accessible to an analyzer that receives a hypothetical value for said variable and, based on said hypothetical value, uses a member of said set of liability values to determine a hypothetical liability for said retirement benefit plan.

2. The method of claim 1, wherein said analyzer performs an actuarial valuation of said retirement benefit plan.

3. The method of claim 1,
wherein said variable has a temporal dimension, and
wherein said determining further comprises determining said set of incremental values over said temporal dimension.

4. The method of claim 3, wherein said analyzer performs a deterministic projection of said retirement benefit plan.

5. The method of claim 3, wherein said analyzer performs a stochastic projection of said retirement benefit plan.

6. The method of claim 1,
wherein said variable includes a dimension representing a number of trials, and
wherein said determining further comprises determining said set of incremental values for said number of trials.

7. The method of claim 1, wherein said analyzer interpolates between members of a subset of said set of liability values when said hypothetical value is not represented in said set of incremental values.

8. The method of claim 1, wherein said variable comprises an actuarial assumption.

9. The method of claim 8, wherein said actuarial assumption is selected from the group consisting of (a) an interest rate for determining a present value of a future benefit, (b) a salary assumption for estimating a future salary for an active member of said plan, (c) a decrement assumption to estimate when a benefit might become payable, (d) a mortality rate for determining an expected length of time a benefit will be paid to a member of said plan, (e) a medical benefit claim cost, and (f) an anticipated future health care trend.

10. The method of claim 1, wherein said variable comprises an experience assumption.

11. The method of claim 10, wherein said experience assumption is selected from the group consisting of a future mortality rate for members of said plan, a disability rate for members of said plan, a termination rate for members of said plan, a retirement rate for members of said plan, and a salary increase for a member of said plan.

12. A system for facilitating an evaluation of a financial aspect of a retirement benefit plan, comprising:
a module for determining a set of incremental values between a lower limit value and an upper limit value of a variable relating to said retirement benefit plan;
a module for calculating a liability value for each member of said set of incremental values, thus yielding a set of liability values; and
a module for storing said set of liability values,
wherein said set of liability values is made accessible to an analyzer that receives a hypothetical value for said variable and, based on said hypothetical value, uses a member of said set of liability values to determine a hypothetical liability for said retirement benefit plan.

13. A storage media for controlling a processor that, in turn, facilitates an evaluation of a financial aspect of a retirement benefit plan, said storage media comprising:
a module for controlling said processor to determine a set of incremental values between a lower limit value and an upper limit value of a variable relating to said retirement benefit plan;
a module for controlling said processor to calculate a liability value for each member of said set of incremental values, thus yielding a set of liability values; and
a module for controlling said processor to store said set of liability values,
wherein said set of liability values is made accessible to an analyzer that receives a hypothetical value for said variable and, based on said hypothetical value, uses a member of said set of liability values to determine a hypothetical liability for said retirement benefit plan.
